(19) United States
(12) Patent Application Publication
(10) Pub. No.: US 2015/0324066 A1
(43) Pub. Date: Nov. 12, 2015

(54) Remote Response System With Multiple Responses

(71) Applicant: Macmillan New Ventures, LLC, New York, NY (US)

(72) Inventors: Mats A. Selen, Urbana, IL (US); John W. Sawyer, Indianapolis, IN (US)

(21) Appl. No.: 14/270,981

(22) Filed: May 6, 2014

(51) Int. Cl. G06F 3/0482; H04W 4/00

(52) U.S. Cl. CPC G06F 3/0482; H04W 4/008

(57) ABSTRACT

The present invention is directed to an audience response communication system that enables a user to submit multiple responses to a single question from a presenter. The system comprises a base unit and a plurality of remove input devices. The base unit and the remote input devices include processing units and communication devices such that data is transmitted between the base unit and the input devices. A user is provided with a plurality of input options via the remote input device. Responses are generated by the remote units by receiving an input indicator from the user based on user selection, which are then transmitted to the base unit. While a polling period is open, the input devices may receive additional selections from the user, and generate further response messages that include the user's previous responses as well as any additional selections, which are then transmitted to the base unit. When the base unit receives a response message, it is stored in a memory location assigned to the remote unit. Subsequent response messages from the remote unit are written over previous response messages, such that when the polling session is closed, a remote unit will have a final response comprising the various selections made during polling.

### FIELD OF THE INVENTION

This invention relates to an audience response communication system, and in particular, to a wireless communication method that enables users to submit multiple responses to a single inquiry.

### BACKGROUND OF THE INVENTION

Audience response systems enable groups of people, such as meeting participants, students, or audience members to wirelessly vote on a topic or respond to questions submitted by a host, instructor, or presenter. Different audience response systems are known and have been used in numerous applications including education, audience participation, game shows, voting at conferences, opinion polls, and the like.

Various audience response systems include one or more base station RF transceivers. These base stations may be connected to a computer that may execute audience response system software. The base stations may also be adapted to communicate with several wireless keypads or other input devices adapted to enable a user to select a response to an inquiry. The base station transmits data inviting a response from the remote input devices, Audience members enter their responses to a question posed by the presenter by using their input devices. The audience responses are then communicated to the base station. The responses may then be stored, tallied, and/or displayed using the audience response system software.

While several audience response systems are known and available in the marketplace, there is a desire for an improved system having advanced features beyond typical question and response capabilities.

### SUMMARY OF THE INVENTION

The present invention provides an audience response communication system that allows for a broader range of responses than in prior art systems. Typically audience response systems permit only one answer per user input device per question. The present invention enables a user to transmit more than one answer in response to a single question. For example, a moderator may ask an audience to choose three of their favorite flavors of ice cream.

The audience response communication system includes a base unit and a plurality of remote input devices. The base unit includes a processing unit, such as a computer, and a communication device, such as a wireless transceiver. Similarly, each of the plurality of remote input devices includes a processing unit, such as an IC chip, and a communication device, such as a wireless transceiver that is adapted to communicate with the base unit communication device.

Each of the plurality of remote input devices is configured to provide a user of the remote input device with a plurality of input options. For example, the remote input device may include a plurality of buttons that are marked “1”, “2”, “3”, and “4”; “A”, “B”, “C”, and “D”, or the like. Rather than actual buttons, virtual buttons, such as displayed on a touchscreen, may also be utilized.

The remote input devices further include a processing unit that is programmed such that the remote input device performs certain functions. Some of the functions that the processing unit, when properly configured, enables each remote input device to perform include receiving a first input indicator when the user selects a first input option. For example, if a user presses the “A” button, the processing unit receives an input signal indicating that the “A” option was selected. The processing unit then generates a first response message based on the user selection of the first input option, and causes the communication device of the remote input device to transmit the first response message to the base unit. For example, in the previous example, the processing unit creates a response message containing the selection “A”, which is transmitted to the base unit.

In order to allow the user to make multiple selections, the processing unit enables the remote input device to receive a second input indicator if the user selects a second input option, such as “B”. In this event, the processing unit generates a second response based on the first response and the user selection of the second input option. In this example, the second response comprises the selection of “A” from he first response and the selection of “B” from the second response. After the second response is generated, the processing unit causes the remote input device communication device to transmit the second response to the base unit. During the polling period, the user may continue to make changes to his or her response by selecting from the available input options, including choosing additional inputs and de-selecting previously selected inputs. After each change, a new response message is generated and transmitted.

While the polling session is open, users select one response at a time, with each response operating as an on/off toggle. After each response is selected, the remote sends all of the answers that are toggled on. The last answer that is received when potting is closed is the answer that is retained by the base station. For example, a user is posed a question, and determines that she believes the answer is A, B and D. The user presses the A button, and the A button's corresponding light on the input device is activated. The input device then transmits the response “A” to the base unit. The user then presses the B button. The B button's corresponding light on the input device is activated, such that both the A light and the B light are on. The input device then transmits the response “A and B” to the base unit. This response overrides the previous “A” response. The user then presses the D button and the D button's corresponding light on the input device is activated, such that the A, B and D lights are illuminated. The input device then transmits the response “A, B, and D” to the base unit, This response overrides the previous “A and B” response.

In some embodiments, if the polling time is still open and the user decides that one of her responses is incorrect, she can correct her response. For example, if the user decides that B is not a correct answer, she can press the B button to de-select that choice as an answer. The B button's corresponding light is deactivated such that now only the A and D lights are illuminated. The input device then sends the response message including the “A and D” selections to the base unit. This response overrides the previous “A, B, and D” response. While polling is open, any subsequent changes to a response, whether selecting or deselecting a choice, is reflected in a response transmitted by the input device to the base unit and overrides previous responses.

The base unit is configured to receive a first response from at least one of the plurality of remote input devices and to store the first response in a memory location. In some embodiments, the remote input device may transmit the information via an appropriate wireless protocol directly to a transceiver in the base unit. In other embodiments, the remote input devices may transmit the information to the base unit via a computer network or the Internet.

The first response, when received by the base unit, is stored in a memory location identifiable with the particular remote unit. If a second response is received, which would occur if the user either adds a selection or changes a selection, the base unit will substitute the response corresponding to the particular remote input device from the first response to the second response, so that after the polling period has concluded only a single response will match up to a particular remote unit.

A preferred system may also provide the user with an indication that his or her response was too late. After polling has concluded, the base unit will no longer accept responses. If the user attempts to submit a new response, the light corresponding to the new selection or de-selection will be illuminated with a different color or will flash or both so as to indicate to the user that his or her response was not accepted by the base unit. It is further preferred that the input device will also illuminate a different color or flash if a response is not received by the base unit for reasons other than expiration of the polling period, such as a wrong frequency, interference from other voters, signal transmission interference, or any other occurrence that could cause a vote to be received.

In a preferred embodiment, the final responses, e.g., the last response submitted by a user during the polling period, are aggregated and displayed to the instructor or moderator. The information displayed can be configured as desired, such as to simply show the number of users selecting each of the choices, or may display more detailed information breaking down the responses by a particular demographic, e.g., age, gender, race, etc.

These and other objects, advantages and features of this invention will become apparent upon review of the following specification in conjunction with the drawings.

### BRIEF DESCRIPTION OF THE DRAWINGS

FIG. 1 illustrates an audience response communication system according to one embodiment of the present invention;

FIG. 2 illustrates an audience response communication system according to another embodiment of the present invention;

FIG. 3 illustrates a preferred embodiment of a remote input device of the audience response communication system;

FIG. 4 illustrates an alternative preferred embodiment of a remote input device of the audience response communication system;

FIG. 5 illustrates a process by which multiple responses are generated and transmitted by a remote input device; and

FIG. 6 illustrates certain processes of the base unit.

### DETAILED DESCRIPTION OF PREFERRED EMBODIMENTS

The detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

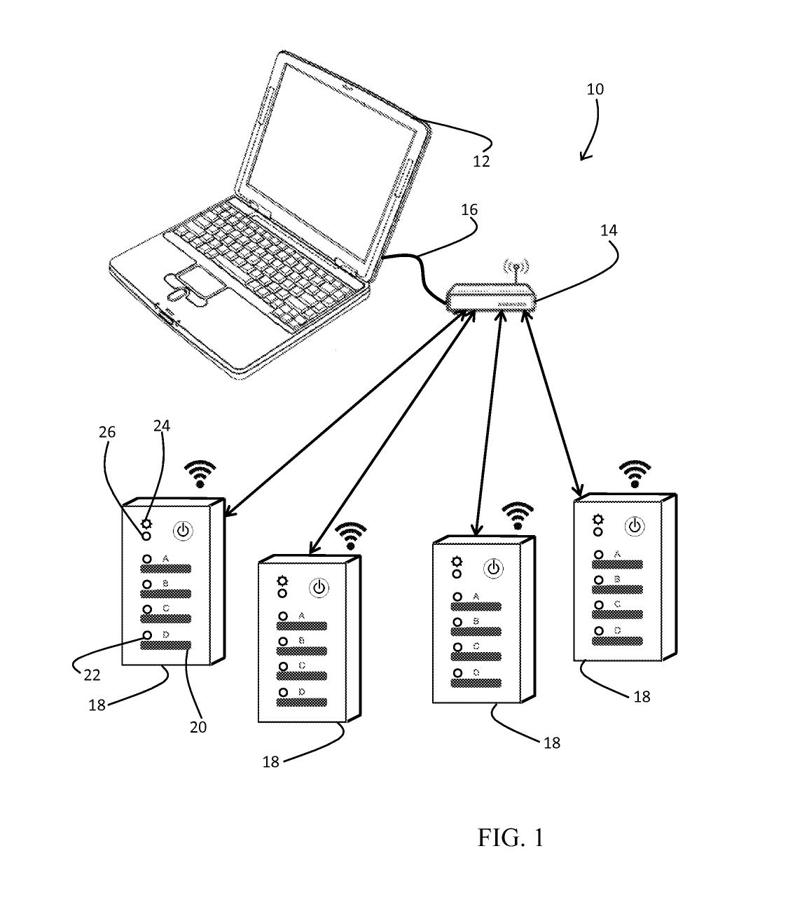

Referring to FIG. 1, a schematic of a preferred embodiment of a system according to the present embodiment is depicted. System 10 comprises a base unit, which in this embodiment comprises a computer 12 and a communication device such as wireless transceiver 14. While in this embodiment the computer 12 and wireless transmitter are connected by a USB connector 16, the base unit may be an integrated unit where the computer includes an internal wireless transceiver. The computer 12 may also include the software to operate the system in memory, or access such software via a wired network or a wireless connection, such as the Internet. Alternatively, the wireless transceiver 14 may be a wireless dongle that also includes the software run by the base unit. The computer 12 shown is a conventional laptop computer; however, any computing device adapted to run the appropriate software may be utilized, such as a desktop computer, smartphone, tablet computer, or the like.

Adapted to wirelessly communicate with transceiver 14 are a plurality of remote input devices 18. Each of the plurality of remote input devices includes a communication device such as a transceiver that is adapted to communicate with the base unit. Each of the plurality of remote input devices is configured to provide a user with a plurality of input options. In the embodiment shown, each of remote input devices 18 includes a plurality of pressable keys or buttons as the input options 20. As shown, in this embodiment, the user is provided with input options “A”, “B”, “C”, and “D”. Any number of input options, or configurations for the remote input device may be utilized. Each of the input options has an LED light 22 associated with it. In this embodiment, LED lights 24 and 26 are also provided to indicate that the remote input device is powered on and also to indicate device status. For example, light 24 may emit a green light to indicate that polling is open, while light 26 may emit a red light to indicate that polling is closed. LED lights 24 and 26 may also be adapted to flash to indicate lack of connection with the base unit.

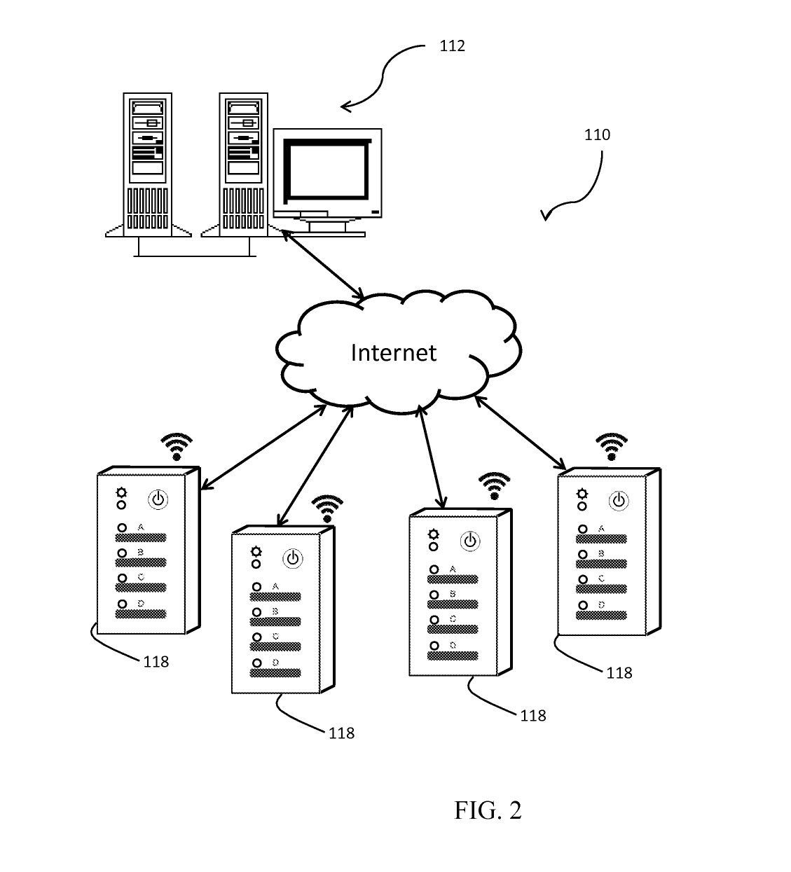

An alternative embodiment of the response system 110 is show in FIG. 2. Rather than the base unit comprising a computer in the same location as the remote input devices, the base unit may reside in a separate geographic location. The base unit may comprise a distributed network server 112 that communicates via the Internet to the remote input devices 118. In this configuration a single base unit, such as server 112, may also serve as the base unit for numerous response systems.

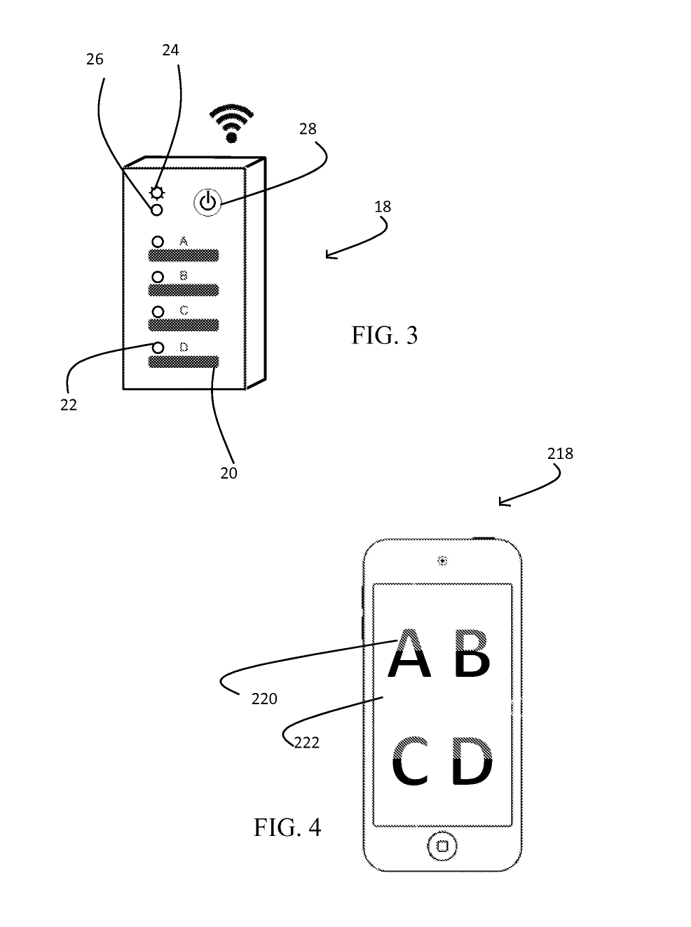

Two examples of remote input devices are shown in FIGS. 3 and 4. Referring to FIG. 3, a remote input unit 18 from FIG. 1 is shown. Each remote input device 18 is provided with a power button 28. Referring to FIG. 4, a smartphone or tablet computer based remote input unit is depicted. In this example, smartphone 218 is shown. Although not shown, the smartphone or tablet may include an attachable transceiver module. The particular smartphones or operating systems are within the discretion of the system provider. As shown, smartphone 218 displays on screen 222 a plurality of input options 220. The particular choices displayed may take any desired form. For example, rather than present letter choices to the user, number choices, pictographic choices, or full text answer choices may be presented. In a preferred embodiment, selection by a user of a particular choice wilt cause the display of that choice to change, e.g., change color, become highlighted, or the like, so as to indicate that it has been selected. It is contemplated that the audience response communication system may include any combination of input devices, e.g., a combination of tablet computers, smartphones, and remote input units. The specific type of input device may include any type of device wherein the user may select from a plurality of input options, and the input device transmits selected input options to the base unit.

Each of the remote input devices further includes a processing unit. The processing unit is programmed to perform certain tasks, which are discussed in greater detail below with regard to the description of a preferred embodiment of a polling session.

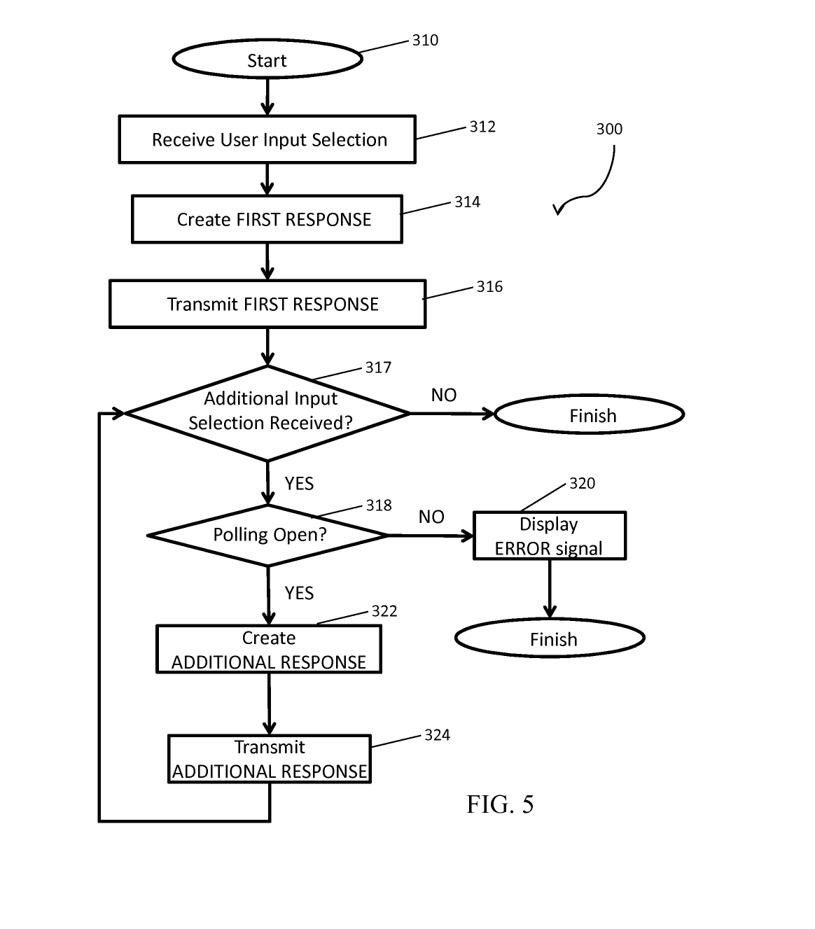

Referring to FIG. 5, some of the functions of the processing unit of the remote input device related to multiple responses are described in flowchart 300. A user may press the power button 28 on the remote (FIG. 3), which causes the processing unit to power on or start as shown in box 310. Various authentication and validation steps may be performed to sync and qualify the remote input device with the base unit as is known in the art. For example, after a user turns a remote unit on, the unit will automatically start scanning all of the available broadcast channels for an in-range base unit.

A presenter or moderator will present the users with a question from which the users will make one or more choices from the input options. A user may select a choice by pressing a button, such as shown by input options 20 in the remote input unit 18 of FIG. 3, or by touching the portion of screen 222 with the desired choice displayed, such as shown in the remote input unit 218 of FIG. 4. The processing unit is configured to receive a first input indicator when the user selects a first input option, as shown in box 312. For example, the user may push the “A” button, such that the processing unit receives a signal corresponding to the “A” button. The received signal is preferably an analog or digital electrical signal corresponding to a particular input choice, e.g., “A”, “B”, “C”, etc. The processing unit is preferably a CC2543 System-on-Chip device that combines radio functionality with an 8051 CPU. The processing unit then creates a message called a FIRST RESPONSE (box 314), and transmits this FIRST RESPONSE (box 316). In a preferred embodiment, the message includes the user selection, identifying information such as a room code and remote identification code, and uses encryption to protect this information. It is further preferred that the base unit, upon receiving a message, transmits to the particular emote unit an acknowledgement signal. Upon receipt of the acknowledgement signal the processing unit of the remote unit may provide the user with an indicator that the response was submitted, such as a vibration, audible alert, visual alert, or any combination of these.

If the user wishes to select another input selection, he or she may do so by pressing an additional button. If no additional input selection is made, then the process of submitting a response is completed. If an additional selection is made (box 317), such as by the user pushing the “B” button, the processing unit determines whether polling is open (box 318). If polling is not open, an error signal is displayed (box 320). For example, referring to the input device 18 of FIG. 3, if polling is closed and the user attempts to select “B”, the LED associated with the new “B” selection may flash or emit a warning color to indicate that the selection was not submitted. If, however, polling is still open, the processing unit creates a second response, which is shown in box 322 as the generation of a message called ADDITIONAL RESPONSE. The message created for the ADDITIONAL RESPONSE will include both the “A” and “B” selections. The processing unit then causes the remote input device's communication device, such as a wireless transceiver, to transmit the second response to the base unit (box 324). If an additional input is made, such as the selection of button “D”, a new ADDITIONAL RESPONSE is generated and transmitted. As described, the user may also choose to de-select a previous selection by pressing a button that was already selected. For example, if the user previously selected “A”, “B”, and “D”, but wants to change his or her answer to “B” and “D”, he or she may select and press the “A” button again. The new ADDITIONAL RESPONSE that is generated will now contain the message “B” and “D” selections.

As long as the polling session is open, the processing unit of the remote input devices will wait to see if any additional inputs, both selections and de-selections, from the user are received. The polling time may be preset by the presenter, or may be terminated by the presenter at his or her discretion.

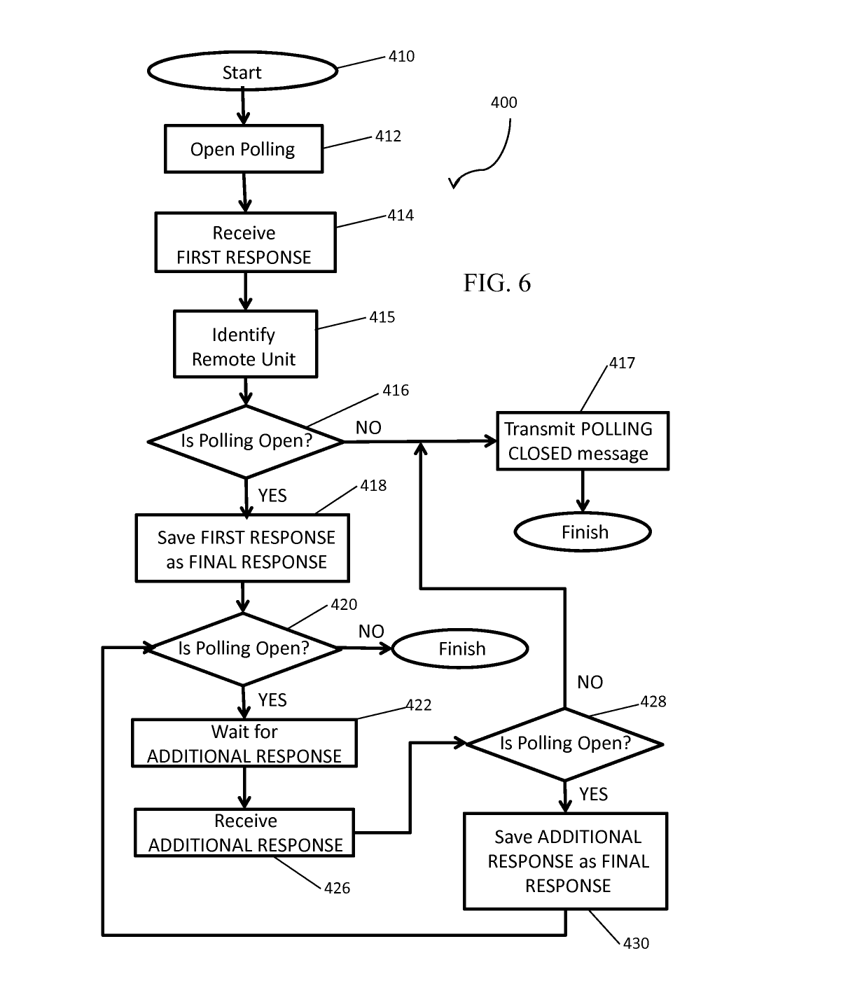

The base unit includes a processing unit that is configured to receive responses from the remote input devices, Referring to flowchart 400 FIG. 6, the presenter or mediator powers the base unit on to start the system (box 410). After which, the presenter or mediator poses a question to the users eliciting responses. The presenter or mediator then opens polling (box 412). The opening of polling may be by way of pressing a button on the computer, or may be automatically initiated a predetermined amount of time after a question is presented. As discussed, when a user makes a selection and generates a FIRST RESPONSE, that selection is transmitted to the base unit. The base unit receives the FIRST RESPONSE via its communication device, such as a wireless transceiver (box 414). Included with the FIRST RESPONSE message will also be some indicator of from which remote input device the FIRST RESPONSE was transmitted (box 415). The base unit then queries to determine whether polling was open when the FIRST RESPONSE was transmitted (box 416). If the polling session was closed, the base unit will transmit a POLLING CLOSED message (box 417). The POLLING CLOSED message may take the form of a signal to the transmitting remote input device to flash an LED light or otherwise indicate that polling was closed and that the submission was not recorded.

If, however, polling is open, the FIRST RESPONSE is saved in memory as a FINAL RESPONSE (box 418), along with the information identifying the remote unit that transmitted the response. If polling is still open (box 420), the base unit will wait for a subsequent ADDITIONAL RESPONSE (box 422). Otherwise, the process of collecting responses is ended (box 420). If polling is open, the base unit will wait for further responses, which are referred to as ADDITIONAL RESPONSE (box 422). If an ADDITIONAL RESPONSE is received (box 426), the base unit processing unit again determines whether polling was open when the ADDITIONAL RESPONSE was transmitted (box 428). If polling was closed, the base unit will transmit a POLLING CLOSED message (box 417). If polling was open, the ADDITIONAL RESPONSE is saved as FINAL RESPONSE (box 430), thereby overwriting the previous FINAL RESPONSE. Additional responses may be received and recorded so long as polling is open.

It is understood that the exemplary system and method described herein and shown in the drawings represent only presently preferred embodiments of the invention. Various modifications and additions may be made to such embodiments without departing from the spirit and scope of the invention.

What is claimed is:

1. An audience response communication system, the system comprising:
abuse unit and a plurality of remote input devices;
the base unit including a communication device and each of the plurality of remote input devices including a communication device adapted to communicate with the base unit communication device;
each of the plurality of remote input devices configured to provide a user with a plurality of input options, the remote input devices further including a processing unit, the processing unit of each remote input device configured:
to receive a first input indicator when the user selects a first input option;
to generate a first response based on the user selection of the first input option,
to cause the remote input device communication device to transmit the first response to the base unit,
to receive a second input indicator if the user selects a second input option,
to generate a second response based on first response and the user selection of the second input option,
to cause the remote input device communication device to transmit the second response to the base unit,
a base unit processing unit configured to receive first response from at least one of the plurality of remote input devices and to store the first response in memory, the base unit processing unit further configured to receive at least one second response from at least one of the plurality of remote input devices and substitute in memory the first response with the second response.

2. The audience response communication system of claim 1 wherein the remote input devices comprise a personal computing device.

3. The audience response communication system of claim 2 wherein the personal computing device is a smartphone.

4. The audience response communication system of claim 2 wherein the personal computing device is a tablet computer.

5. The audience response communication system of claim 1 wherein the remote input devices communicate with the base unit via the Internet.

6. An audience response and communication system, the system comprising:
a base unit and a plurality of remote input devices, the base unit adapted to communicate with each of the plurality of remote input devices;
each of the plurality of input devices adapted to display a plurality of input options to a user, each of the plurality of input devices further including a processing unit configured:
(a) to receive a first input indicator after the user selects a first input from the plurality of input options;
(b) to generate a first response message based on the first input indicator corresponding to the user selected first input,
(c) to cause the remote input device to communicate the first response message to the base unit by way of a wireless transmission,
(d) to receive an additional input indicator if the user selects an additional input from the plurality of input options;
(e) to generate an additional response message upon user selection of one of the plurality of input options, the additional response message including the first input indicator and the additional input indicator;
(f) to cause the input device to communicate the additional response message to the base unit by way of a wireless transmission, and
(g) to perform functions (d)-(f) after the user selects a further additional input from the plurality of input options;
a base unit processing unit configured to receive the first response message from at least one of the plurality of input devices and to store the first response message in memory assigned to at least one of the plurality of input devices, the base unit processing unit further configured to receive at least one second response from at least one of the plurality of remote input devices and to substitute the first response message with the second response message in the memory assigned to at least one of the plurality of input devices.

7. The audience response communication system of claim 6 wherein the remote input devices comprise personal computing devices.

8. The audience response communication system of claim 7 wherein the personal computing devices include a smartphone.

9. The audience response communication system of claim 7 wherein the personal computing devices include a tablet computer.

10. The audience response communication system of claim 6 wherein the remote input devices communicate with the base unit via the Internet.
